(19) United States
(12) Patent Application Publication
(10) Pub. No.: US 2025/0337984 A1
(43) Pub. Date: Oct. 30, 2025

(54) A SCREEN TIME CONSTRAINING DEVICE AND A METHOD FOR CONSTRAINING

(71) Applicant: LIFETECH BALANCE PTY LTD, Victoria (AU)

(72) Inventor: Peter KARKIS, Victoria (AU)

(73) Assignee: LIFETECH BALANCE PTY LTD, Victoria (AU)

(21) Appl. No.: 18/866,876

(22) PCT Filed: Apr. 27, 2023
(86) PCT No.: PCT/AU2023/050345

§ 371 Date: Nov. 18, 2024

(30) Foreign Application Priority Data
May 18, 2022 (AU) 2022901330

(51) Int. Cl. H04N 21/45; H04N 21/442

(52) U.S. Cl. CPC H04N 21/45; H04N 21/44213

(57) ABSTRACT

Disclosed herein is a screen time constraining device (10). The device (10) is in signal communication with an electronic display (12). The device (10) is configured to determine whether a screen time constraint condition for a user that is logged into the device (10) is satisfied.

### TECHNICAL FIELD

The disclosure herein relates to a screen time constraining device and a method for constraining screen time.

### BACKGROUND

A person's screen time can be defined as the amount of time the person spends using one or more electronic devices having an electronic display (“screen”). Generally, but not necessarily, screen time is expressed as the number of hours per day spent using the one or more devices.

Examples of common electronic devices that contribute to screen time include but are not limited to smartphones, tablets, computer monitors, computers, and television sets either connected or not connected to video information sources such as video game consoles, set top boxes, and DVD and BlueRay players.

Screen time can adversely impact child development, mental and physical health including:
Impair sleep
Increase weight gain and obesity
Increase consumption of unhealthy food
Increase anxiety and depression
Reduce cognitive outcomes for children
Lower educational outcomes

The impact of screen time on a person increases as their screen time increases. To prevent adverse outcomes from screen time, some governments have placed regulations for limiting the use of devices with a screen. It may be difficult to enforce screen time limits. In 2019, the World Health Organization issued the following recommended screen time limits for children under 5 to limit adverse health effects:
Birth to age 1: No sedentary screen time
Ages 2-4 No more than 60 minutes of sedentary screen time.

It may be desirable to be able to more efficiently enforce screen time limits for individuals, particularly children, which may reduce the adverse effects of excessive screen time, for example when screen time is not balanced with other parts of life. It may be advantageous to incentivize individuals to undertake activities away from screens.

### SUMMARY

Disclosed herein is a screen time constraining device configured to monitor for satisfaction of a screen time constraint condition for a user, and when the screen time constraint condition is satisfied, prevent display of video information from a video information source selected by a user.

An embodiment comprises a communications interface and a processor in communication with the communications interface, wherein the processor is configured to, when the screen time constraint condition is satisfied, send via the communications interface command information indicative of a command to switch the active source of video information from the user selected video information source to another source of video information.

In an embodiment, the other source of video information is the communications interface.

In an embodiment, the processor is configured to generate video information and send the generated video information to the communications interface.

In an embodiment, the generated video information is in a HDMI format.

In an embodiment, the communications interface comprises a High-Definition Multimedia Interface (HDMI).

In an embodiment, at least one of the command information and the command complies with the Consumer Electronics Control (CEC) protocol defined by a HDMI specification.

In an embodiment, the communications interface is in signal communication with an electronic display.

In an embodiment, the electronic display is the root device and has at least one of a physical address of 0 and a logical address of 0.

An embodiment comprises a computer network interface for receiving, from a remote information store, accumulated screen time information indicative of the user's accumulated screen time on at least two electronic devices, and the screen constraint condition incorporates the accumulated screen time information, wherein one of the at least two electronic devices is in communication with the communications interface.

An embodiment comprises a computer network interface for receiving, from an information store, accumulated screen time information indicative of the user's accumulated screen time on at least one electronic device, and the screen constraint condition incorporates the accumulated screen time information.

In an embodiment, the information store is a remote information store.

In an embodiment, the computer network interface comprises an IEEE 802.11 communications interface.

In an embodiment, the screen time display constraint condition defines a time the user is not permitted screen time.

In an embodiment, the screen time constraint condition defines a maximum quantity of screen time for the user.

Disclosed herein is a method for constraining screen time, the method comprising:
monitoring for satisfaction of a screen time constraint condition; and
prevent display of video information from a video information source selected by a user.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows an embodiment of a screen time constraining device in an example use case.

FIG. 2 shows a flow diagram comprising steps of an embodiment of a method executable by the device of FIG. 1.

FIG. 3 shows a schematic block diagram of the hardware architecture of the device of FIG. 1.

FIGS. 4 to 7 each show a sequence of steps of an embodiment of a method executed by the device of FIG. 1.

FIG. 8 shows the device of FIG. 1 in communication with an information store over a network.

FIG. 9 is an example software architecture view of the device and the information store 201.

FIG. 10 shows a flow diagram for an example operation of the device of FIG. 1.

FIGS. 11 to 14 show examples of various visual interfaces.

### DESCRIPTION OF EMBODIMENTS

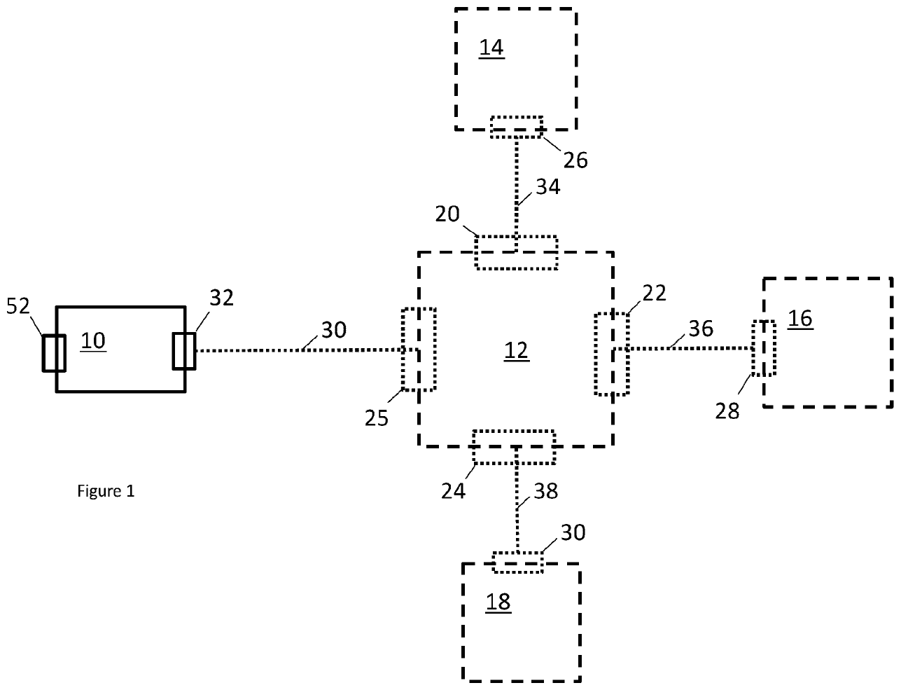

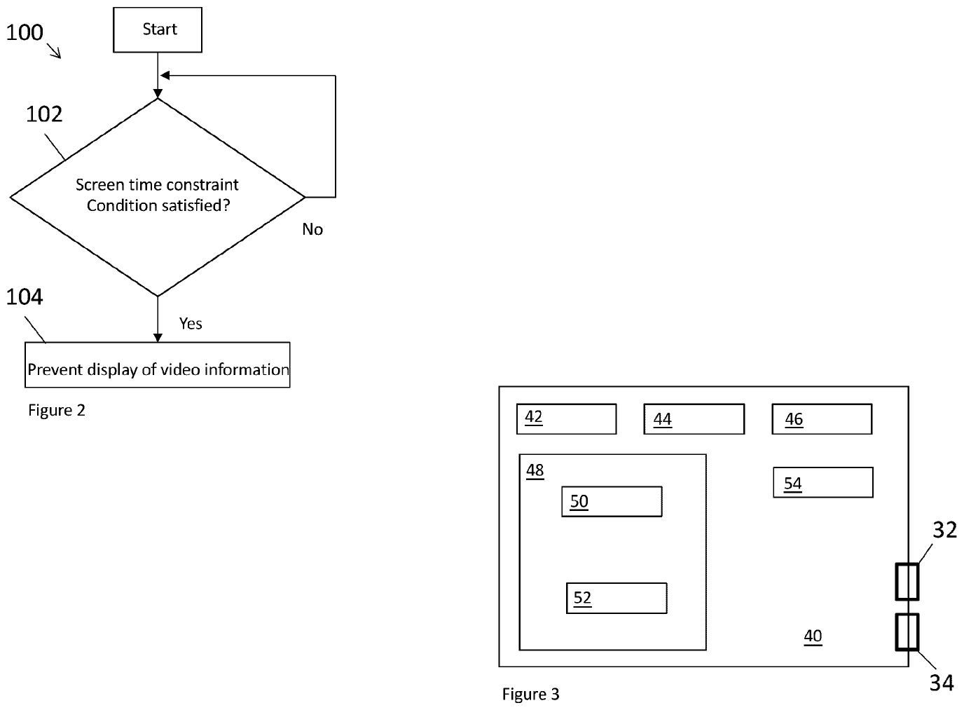

FIG. 1 shows an embodiment of a screen time constraining device, generally indicated by the numeral 10, in an example usage case. The device 10 is in signal communication with an electronic display 12. The device 10 is configured to determine whether a screen time constraint condition for a user that is logged into the device 10 is satisfied. FIG. 2 shows a flow diagram comprising steps of an embodiment of a method 100 executable by the device 10 for constraining screen time. In a step 102, the device 10 determines whether a screen time constraint condition is satisfied. If not, then generally but not necessarily, the video information from a video information source is not blocked. Step 104 is performed when the screen time constraint condition is satisfied, in which the device 10 prevents display of video information from a video information source 14. As illustrated in FIG. 1, the video information can be sent by a video information source, for example one of the video information sources 14,16, 18 that are in communication with the display 12. Generally, the active video information source is selected by a user of the electronic display 12. As is shown in the flow diagram of FIG. 2, in the present but not necessarily in all embodiments, the device 10 monitors whether the screen time constraint condition is satisfied, and prevents display of the video information when it is so satisfied. In an alternative embodiment of the method 100, after preventing display of the video information, step 102 is re-evaluate whether the screen time constraint condition is satisfied.

Various example of screen time constraint conditions:
define at least one time, the user is not permitted screen time, for example the following time periods:
   between 8 pm on a school night and 3 pm the following school day, and
   between 9:30 am and 2 pm on Saturdays and Sundays.
define the maximum allowed user screen time for a period, for example:
   more than 1 hour on a school day
   more than 3 hours on a weekend day or a public holiday
   more than 0 hours on Christmas day (i.e. no screen time), and
   more than 7 hours in a week.
incorporate accumulated screen time information associated with the display 12 and at least one other electronic device with an electronic display.

In the example use case shown in FIG. 1, the electronic display 12 is in the form of a television 10 set in a premises in the form of a home with a child user of the television set. An example of a suitable television set is a Samsung Neo QLED 8K, however generally any suitable television set may be used as desired. The display 12 comprises a display controller in the form of a display controller board comprising a digital signal processor and a plurality of HDMI ports comprising HDMI protocol compatible connectors 20,22,24 in the form of HDMI type-A sockets in signal communication with the digital signal processor, and other external input device ports. The digital signal processor is configured to receive and/or send information in accordance with a HDMI protocol (“HDMI information”). The HDMI information generally comprises at least one of video information sent on a transition-minimized differential signaling (TDMS) channel, consumer electronics control (CEC) information sent on a CEC channel and display information sent on a display data channel (DDC). The display 12 is generally, and in this example, the root device and has at least one of a HDMI physical address of 0 and a HDMI logical address of 0. The video information sources shown in FIG. 1 include a gamming console 14, a streaming service set top box 16, and a DVD player 18, however generally any suitable video information sources can be in communication with the display 12 as desired. The video information sources 14, 16, 18 each comprise a HDMI port 26,28,30 comprising a HDMI compatible connector in the form of, for example, s type-A HDMI socket. The HDMI ports 26,28,40 of the video information sources 14,16,18 are connected—and consequently in signal communication-via communication cables in the form of HDMI cables 34,36,38 with the HDMI ports 20,22,24 of the display 12. The HDMI cables are in the form of category 3 HDMI cables that have a HDMI type-A plug at each end. The display 12 is operable to display video information received from any of the video information sources 14,16,18, (in additional to device 10) each of which can have a non-conflicting HDMI address selected from the addresses 1 to 15, for example. The display 12 comprises a machine-user interface in the form of a remote control unit, or alternatively the display 12 may have controls in the form of buttons. When the screen time constraining device 12 is not connected to the display 12, the machine-user interface is operable by the user to activate a selected one of the plurality of HDMI ports 20, 22, 24. It is the video information received by the active HDMI port of the plurality of ports that is displayed by the display 12. In this example, the blocked video information sources connected to the display 12 can be HDMI, VGA, RCA, composite sources, or generally any other sources for example.

FIG. 3 shows a schematic block diagram of the hardware architecture of the screen time constraining device 10. The device comprises:
The processor 48 in the form of a single-board computer running LINUX, the processor 48 comprising
   a central processing unit 50 (CPU) in the form of a 32 bit ARM (version 7 rev 5) CPU
   a computer network interface 52 in the form of a wireless computer network interface, specifically an IEEE 802.11 (“Wi-Fi”) integrated circuit and antenna, which can be used to connect to the home's Wi-Fi network.
   Non-transitory processor readable tangible media 54 in communication with the CPU and in the form of flash memory or alternatively a hard drive or generally any suitable form of persistence memory, which includes program instructions which when executed by a processor causes the processor to perform a method disclosed above, and can also include data.
A communications interface 32 in the form of a HDMI port comprising a type-A HDMI socket and in signal communication with the processor 48.
At least one other optional communications interface 34 in the form of another HDMI port comprising a type-A HDMI socket in signal communication with the processor 48. The processor can cause video information received at the other communications interface 34 to be sent to the communications interface 32 for transmission therefrom
A plurality of indicator lights 42 comprising a plurality of LEDs in communication with and controlled by the processor 48, the LEDs providing information to users, for example remaining screen time when logged in, and status information when logged out.
A control signal receiver 44 in communication with and controlled by the processor 48 for receiving control signals, for example infrared control signals from an infrared remote control.
A sound indicator in the form of a buzzer 46 in communication with and controlled by the processor 48; and
a capacitor 54, which stores electricity to power the buzzer 46 when power has been disconnected.
A power socket in the form of a USB socket.

As shown in FIG. 1, the HDMI port 32 of device 10 is connected—and consequently in signal communication—with the HDMI port 25 of the display 12 via a communications cable in the form of a HDMI cable 30. The HDMI cable 30 is in the form of a category 3 HDMI cable that has a HDMI type-A plug at each end. The device 10 can have a non-conflicting HDMI address selected from the addresses 1 to 15, for example. The processor 48 is configured to, when the processor 48 determines that the screen time constraint condition is satisfied, send via the communications interface 32 command information indicative of a command to switch the active source of video information from the user selected video information source to another source of video information. At least one of the command information and the command comply with the Consumer Electronics Control (CEC) protocol defined by a HDMI specification. In this particular embodiment, the command instructs the display 12 to make the HDMI port 25 the display's active HDMI port, and consequently the device 10 the active source of video information—this may force a user to login before the display 12 can be used as desired by the user. The processor 48 is configured to generate video information in a HDMI format and send the generated video information to the HDMI port 32. When the HDMI port 25 is made active, the video information from the user selected source of video information (one of video information sources 14,16,18) ceases to be displayed on the display 12, and is replaced with video information from the device 10. This will generally cause the user to become disinterested in the display and so cease accumulating screen time on the display. The user may instead perform an activity to earn additional future screentime. Internal video information sources of the display 12—for example an internal free to air tuner, and applications running on the display 12—are similarly managed.

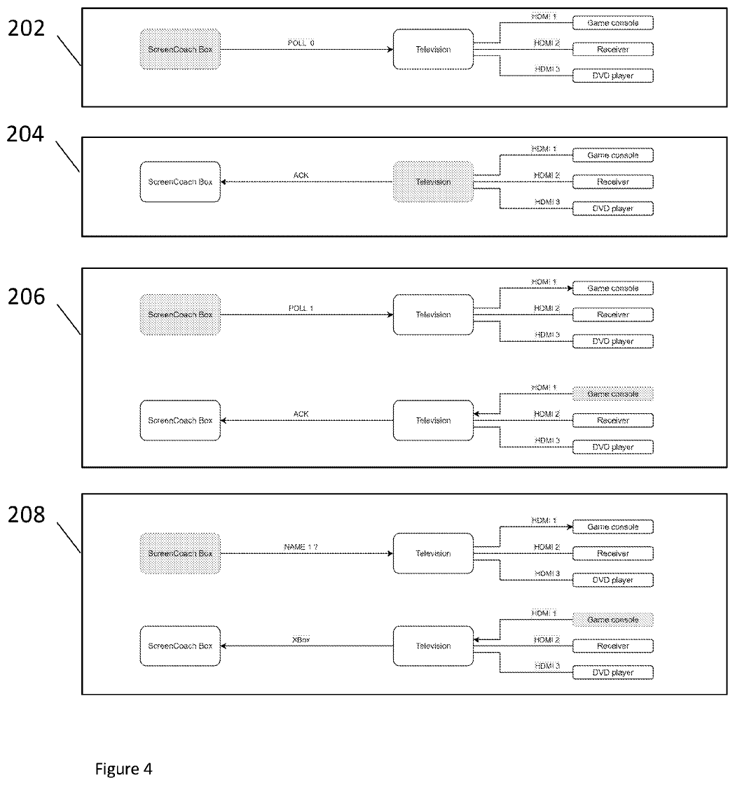

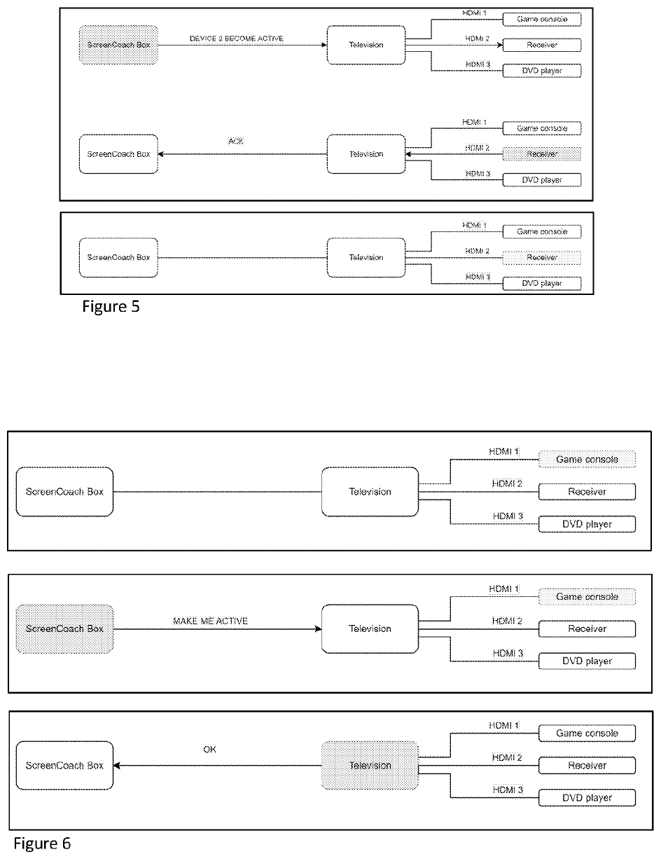

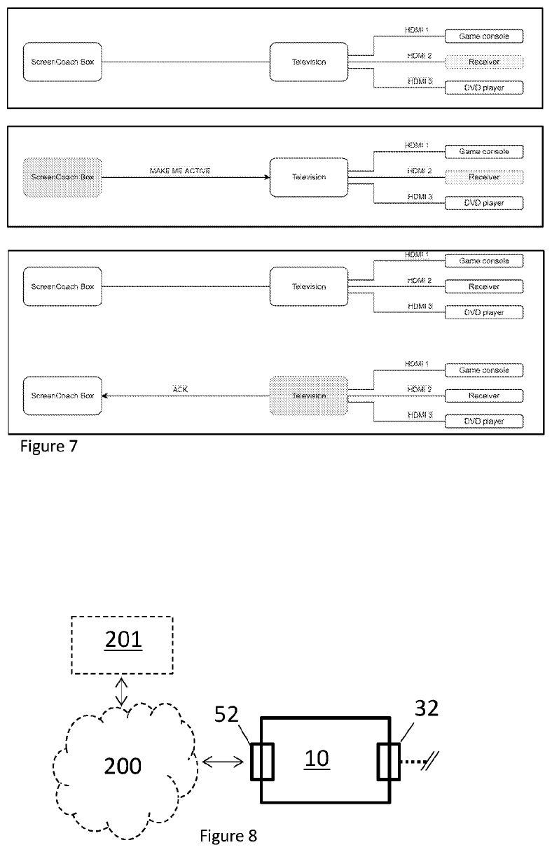

The device 10 sends at least one CEC command via the HDMI port 32 to determine what video information sources are connected to the HDMI ports of the display 12, and to instruct the display 12 to make a user selected HDMI port for a particular video information source the active HDMI port. FIG. 4 shows a sequence of steps of an optional embodiment of a method executed by the device 12 when it starts up, for example. In start-up step 202, the device 10 sends CEC command “POLL 0” via the HDMI port 32. This is to determine if the display 12 is connected. In step 204, the indicator lights are lit green if the display 12 responds. If the display 12 does not respond, the indicator lights optionally flash red indicating an error because, for example, the display 12 is not on, connected or does not understand the CEC protocol. In step 206, the device 12 sends CEC POLL command to each of the HDMI addresses (say, 1 to 15) to determine whether there is a video source device at each HDMI address. In step 208, for each video source device that optionally responded, the device 12 sends a CFC command requesting the device's name, manufacturer and physical address. The received information is incorporated in video information as a list of devices that can be sent to the display 12 for display. FIG. 5 shows a sequence of steps of an embodiment of a method executed by the device when a user starts a session by logging in. FIG. 6 shows a sequence of steps of an embodiment of a method executed by the device 10 when a user is not logged in, wherein the device 10 periodically forces itself to become the active source, for example every 5 seconds or generally any suitable time period. If a user switches to a game console (or other video information source) without logging in first, the display 12 is switched away from the game console and back to the device 10. FIG. 7 shows a sequence of steps of an embodiment of a method executed by the device 10 when a login session ends. When a session ends, for example by a user pressing the play/pause button (for example on the remote control) or logging out via the app or the TV is switched off, or if time runs out, the device 10 sends a CEC command to the television to make the device 10 the active source.

It will be appreciated that the user may have already accumulated screen time on another electronic device—for example an iOS, Android, Web App, Mac or Windows device—prior to using the display 12. It may be desirable to account for this already accumulated screen time when determining whether the screen time constraint condition is satisfied. As shown in FIG. 8, the device 10 is optionally configured to receive—via the computer network interface 52 and a computer network 200 (or internetwork such as the internet)—accumulated screen time information indicative of the user's accumulated screen time on at least one other electronic device, for example one or two electronic devices. The accumulated screen time information is stored in and sent to the device 10 by an information store 201 in the form of a remote information store comprising a computer server in communication with the network 200. The remote information store comprises at least one of an API gateway, an electronic database and a web server. The screen constraint condition used by the device 10 can optionally incorporate the accumulated screen time information. For example, the remote information store 201 may have information about the amount of time the user has been using a tablet computer and/or smart phone during a period, for example that day. The processor adds the accumulated screen time indicated by the accumulated screen time information to the user's screen time on the display 12 when determining whether the screen time constraining condition is satisfied. If the device 10 is unable to receive the accumulated screen time information from the information store 200—for example the device 10 is offline, there is no network connection, or the information store is non-operational—then the screen time constraint condition is evaluated based on what was previously known before going off line. Any offline usage is sent to the information store 200 when back online, which will then adjust the overall balances for users.

Connecting the device 10 to the internet can be done in one of two ways:
1. Using the device's remote control to enter a Wi-Fi password for an existing Wi-Fi network
2. Using another network-enabled device to connect to the device's own temporary network, then they can follow the institutions on how to connect the device to the local Wi-Fi network

Linking to an account on the information store 201 can be done in one of three ways:
1. Via a local network connection, enter the account code via the device's admin page available via a web browser.
2. By entering a pairing code (shown on the television/monitor) into the cloud management web portal. A user must log in to their cloud account before doing this.
3. By entering the appropriate authentication details using a compatible device remote control using the interface on the television/monitor.

Some electronic displays, for example some television sets and monitors, are not compatible with the functionality of the device 10 described above (the “first mode”). This may be because, for example, some electronic displays only have a single HDMI port or are unable to act on the command information—for example they do not support CEC. In this case, at least one video information source can be connected to the optional at least one other communication interface 34. In a second optional mode of the device, the video information received at another communications interface 34 can be passed through to the communications interface 32 by an electronic relay controlled by the processor, for example. The processor detects the presence of a video source on interface 34 and internally routes the HDMI data, via a 2-port HDMI switch chip, out of interface 32. The processor can stop the passing through of the video information when the screen time constraint condition is satisfied. An electronic display connected thereto that is not compatible with the described functionality can therefore work with the device 10.

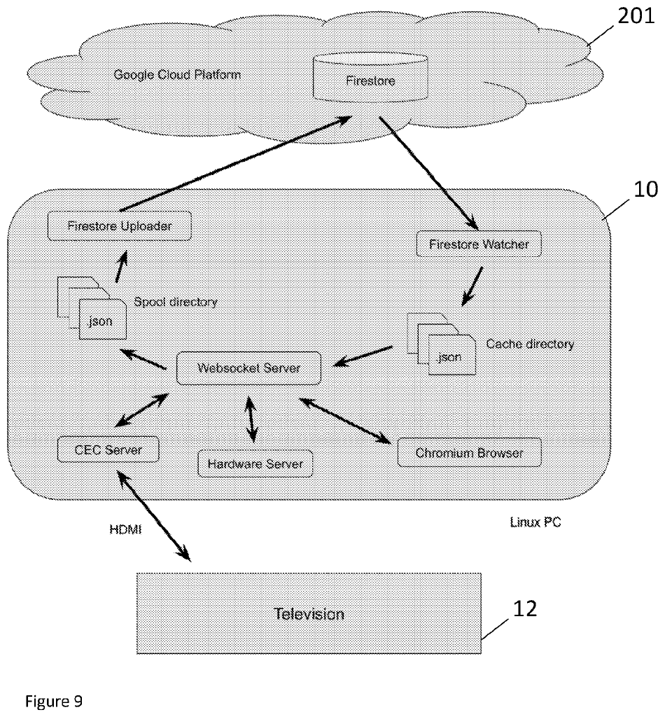

FIG. 9 is an example software architecture view of the device 10 and the information store 201. Generally, any suitable software architecture may be used. Programs are split amongst a plurality of applications that are run as separate processes. The processes includes:
User interface, which is a process implemented in Javascript and HTML, running in a Chromium browser in kiosk mode. The user interface communicates with a Websocket server and a local HTTP server. A Javascript thread monitors the state of the Websocket and if necessary it will destroy and recreate it if there are communication issues. Another thread monitors logged in users and initiates the creation and updating of a session record by sending messages to the Websocket server.
Websocket server, which is a process that communicates with applications on other electronic devices via UDP broadcast packets and Websockets, the local web browser via sockets, and other Linux processes via JSON encoded messages saved as files on disk. This process runs a large chunk of the business logic. When a session, device, heartbeat, or message record needs to be created in Firestore, this process creates .json files in the spool directory. When it needs access to profiles, users, sessions or other Firestore records it reads the .json files from the cache directory. It does not communicate directly with Firestore.
Firestore Watcher, which is a process that uses the Python firebase-admin package. It uses a service account key for authentication (see console .firebase.google.com>project overview>settings>service accounts>firebase admin sdk). This key is used on every device, and it has full access to Firebase. This Python server creates listeners to the following:
   1. the device Firestore record
   2. profiles for this account
   3. avatars for this account
   4. active sessions for this account
   5. a number of other Firestore collections and documents.
Whenever these listeners receive updates from Firestore, they write the records as .json files into a cache directory. When the network goes down (google.com is pinged every 5 seconds) this server unregisters the listeners. When the network comes back up, we create new listeners.
Firestore Uploader, which is a process that uses the Python firebase-admin package to create/update records in Firestore. It watches the spool directory for the creation of .json files and when they appear it will create/update records in Firestore from the contents of those files. Specifically, it does the following:
   1. creates and updates sessions
   2. creates heartbeats
   3. creates and updates the device record
   4. creates action records
   5. creates message records
   6. updates avatar records
If there are networking issues, it simply backs off and tries again later.
CEC server, which is a process that uses the Python CEC library to communicate with the HDMI-connected television using the CEC protocol. It communicates with the websocket server via JSON encoded messages stored in files on disk.
Hardware server software, which is a process that uses Python libraries to interact with the hardware on a custom-built daughterboard. The various hardware components on this board can be controlled by the I2C protocol and by reading/writing the GPIO registers.

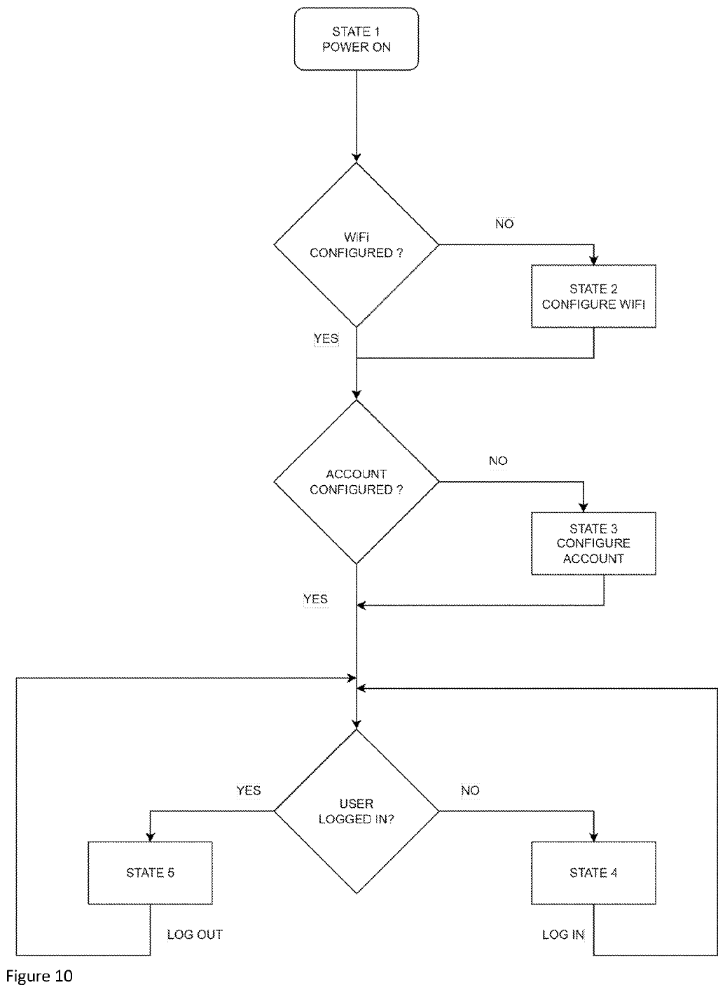

FIG. 10 shows a flow diagram for an example operation of the device 10 from when it is powered, and includes a plurality of states that the device can have. Pseudo code for the different states is:
State 1—power on
   show start-up progress with LEDs
   start monitoring infrared remote control
   start monitoring ports 32 and 34, determine what devices are connected to display 12
   start web server to process HTTP requests
   start web browser and display on device 12
State 2—configure Wi-Fi
   create a Wi-Fi hotspot
   display instructions on display 12
   accept HTTP request from user's browser
      take SSID/password
      connect to home Wi-Fi
   wait for internet connection
   connect to cloud service
      download preferences for device 10
State 3—configure account
   display instructions on device 12
   wait until one the following occur
      HTTP request with ScreenCoach account_id
      watch for account_id being set in cloud
      connect to account in cloud and download list of users, modes, settings for account
State 4—no user logged in
   periodically, switch display 12 HDMI
   to device 10 if port 32 unplugged
      turn on the alarm
      send notification to parent
   indicate status of Wi-Fi/internet connection with LEDs
   show list of allowed users on display 12
State 5—user logged in
   indicate progress of user session with LEDs
   LEDs indicate remaining time on screen, for example as a percentage chart
   allow user to switch device 12 HDMI source
   watch for infrared remote control
      any button press switches device 12 back to device 10
   if a user fails the constraint condition
      they are logged out
      device 12 is switched back to device 10
   if a user fails the constraint condition
      they are logged out
      device 12 is switched back to the device 10.
During normal operation
   watch for button presses on infrared remote control
      convert button presses to cursor movement on device 12
   watch for reboot/reset button
   watch for software updates
      if update available download it
      if forced update
      install when nobody logged in
         reboot the device 10 to apply new code
   if power is disconnected
      turn on the buzzer
   notify account administrators if HDMI is disconnected from port 32
      turn on the buzzer
   flash LEDs red
   notify account administrators

### User Experience

An administration user can configure the device account including adding at least one user account. An administrator user can create a user accounts. Screen time constrain conditions associated with the account can optionally be created by the administrator user using the device's machine-user interface, however generally but not necessarily the administrator uses a web browser or app on another electronic device-examples of which include by are not limited to a PC, laptop computer, tablet computer or smartphone.

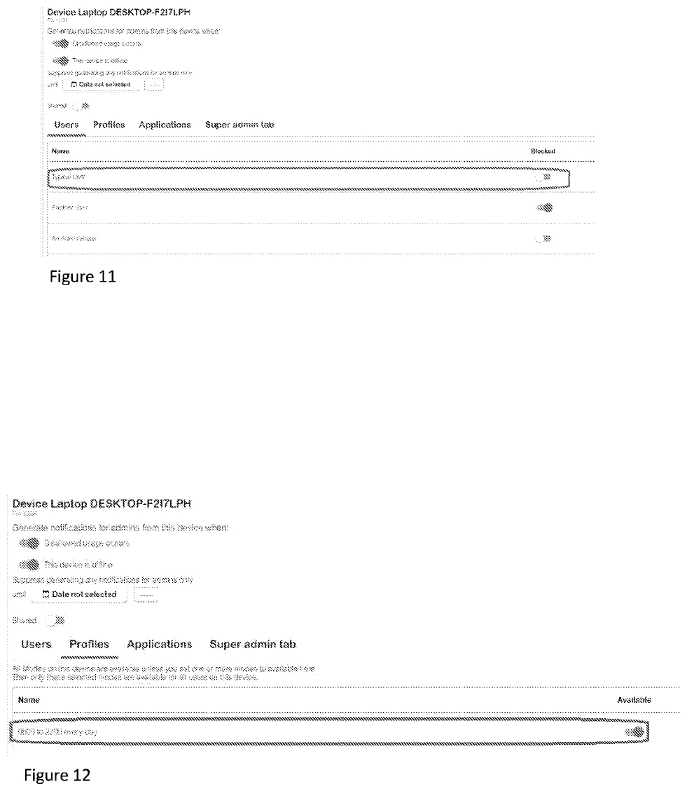

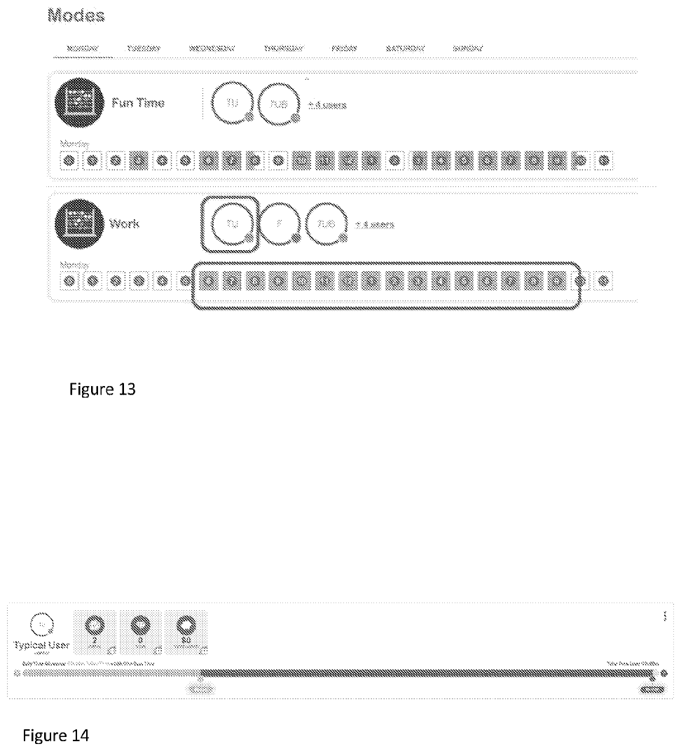

An example of the steps the administrator user engages to define the user's screen time constraint condition is now described. In a step, the administrator user provides access information indicative of whether a user associated with a user account is granted access to the device 12. The visual interface for this step is shown in FIG. 11. In a step, the administrator provides a profile or mode information indicative of whether the user has a profile or mode that allows them to access the device 10. The visual interface for this is shown in FIG. 12. If there is no such profile the user cannot login to the device 10 as there will be no user profile available for them to log into. The laptop of FIGS. 11 and 12 could be any suitable alternative, for example the display 12. FIG. 13 shows a visual interface showing a visual interface for the administrator to modify access times for the modes. The highlighted hours at the bottom of FIG. 13 are the hours of permitted use.

If the user has not been restricted from using to device 12 by the administrator at a specific time, the question then arises whether the user has exceeded their maximum screen time for a specified period of time. FIG. 14 shows a visual interface on a desktop application in which the user's time is shown as a bar coloured blue and green. The green portion of the bar is associated with time tokens associated with the user, which are generally earned by the user. The time the user can use the device 12 depends the green and blue portions of the bar, the rate at which tokens are converted into time, and the rate at which time is counted on the device 12.

Once the device 12 is connected to the display 12 with a HDMI cable and the device account is configured, a list of users is encoded in main screen video information for display on the display 12. A user can select one of the available users with one or more of the following options
The devices' 10 own remote control
The display's 12 own remote control.
Another remote control that can be paired to learn to send the correct key signals to the device 10.
The device's 12 compatible mobile app or app on another smart device's compatible mobile app.

When the display 12 is switched on, the device's login screen will display. This will show all the users who can access the device. Once a user is selected, an optional PIN can be entered to authenticate the user to log them into the device 10. The user may optionally select a mode of operation. Modes are part of the set up options in the system, differing modes giving differing access based on the rules set. Once logged into the device the user can use the display 12 as normal. For compatible displays 12, the user can switch to the TV's HDMI source using the device's 10 remote control, the display's 12 remote control, or an App, for example.

Each time a user logs into the device 10, a user session commences, which tracks the start time, end time and other time billing information such as discounts. As the user uses the device 10, the indicator lights provide a visual representation of the percentage time left—fewer lights are lit as the remaining time reduces. The last indicator light flashes faster as the remaining time approaches zero. The indicator lights have different colours to show when the child is using “base time” (free) or “token time”.

When a user is out of time, the television/monitor returns to the device's 10 login screen with a message to indicate the user has been automatically logged out by the device 10. A user's time usage does not affect any other user's allocated screen time.

If a user has no time left or is trying to log in when not allowed the device 12 will not allow the user to log in and will give them an appropriate error message. The users remaining time for a session can be based on the following logic, for example:
the user's time for the day from their time allowance plus any earned token time.
until the end of the current “allowed usage time”. For example, if the mode they are using has bedtime set at 9 pm then they will be counted down and logged out at 9 PM even if they have available usage time remaining in their user profile.

Additional features include:
Some sessions can be shared, this splits the time used by the number of users sharing a session.
If a user uses more than one device, the additional sessions will be discounted proportionally.
If a user tries to use the television/monitor when they are not allowed to log in, they will be returned to the login screen on the device 10.
If a user unplugs the power or the HDMI cable from the box a buzzer will go off and parents will receive a notification.
Administrators and other linked services can send messages to a user via display 12, if they are logged into the device.
If a user receives a non-urgent message the LEDs will flash in a colour to alert them. This may also be accompanied by a buzzer sound
If a user receives an urgent message or has not responded to a non-urgent message (within an acceptable amount of time), the device switches the source to itself to show the message until the user to acknowledges or responds to the message.
When there are no active user sessions, the device shows status LEDs, these can be different colours and can also flash, to indicate proper functioning or errors/warnings.
Device 10 can turn the display 12 on and off.
Based on the configuration of the device and user's account there are intelligent shortcuts that will help the user login with less steps. For example a TV that only has one allowed user where the user only has one mode for the TV, it will automatically log them in and start a session with no user interaction when the TV is turned on.

Now that embodiments have been described, it will be appreciated that some embodiments may have at least some of the following advantages:
The screen time of a user—for example a child user—can be constrained.
There is significant flexibility in the constraints placed on the screen time.

Variations and/or modifications may be made to the embodiments described without departing from the spirit or ambit of the invention. For example:
The electronic display may comprise a computer monitor, for example a DELL S3219D or generally any suitable and desired computer monitor.
Generally, any suitable HDMI-CEC protocol compatible connector can be used, examples of which include but are not limited to generally any type of HDMI connectors (type A standard HDMI connectors, type B, type C mini HDMI connectors for use with portable devices, type D micro HDMI connectors and type E automotive HDMI connector), USB-C connectors, DisplayPort connectors, Thunderbolt connectors, and generally any suitable and desired connector.
Generally, sockets may be replaced with plugs and vice versa, as appropriate and/or desired.
While the described embodiments use HDMI version 1.4, generally any suitable version of HTML may be used, for example any suitable one of HDMI versions 1.0, 1.1, 1.2, 1.3, 1.4, 2.0, 2.1.
While the described embodiments use category 3 HDMI cables, generally any suitable type of cable may be used, examples of which include but are not limited to HDMI category 1, HDMI category 2, HDMI standard with Ethernet, HDMI high speed with Ethernet, DisplayPort cables, and Thunderbolt cables.
Protocols and hardware other than for HDMI may be used, for example DVI, wireless HDMI, or generally for any suitable media standard.
While the display has been shown connected to three video information sources in addition to the device, there may be any supported number of video information sources connected to the display, for example 1 to 14 additional video information sources.
The display's input sources for all other devices other than device 10 can be non-HDMI sources, such as VGA, Coaxial, Component, SCART, USB, or any other current or future display input sources. Input sources include smart TV apps and free to air TV
When HDMI and CEC are superseded with functionally equivalent or superior interfaces and protocols, the same principles may generally apply to manage the display and any of its other internal or external sources connected to it.
The information store may be attached to the local network (“local information store”), for example a server attached to the local network.
The network interface may generally be any suitable and desired network interface, examples of which include but are not limited to Wi-Fi, a wired IEEE 802.3 (“Ethernet”) network interface, a wired USB network interface, and a Bluetooth network interface.
The machine-user interface may comprise a mouse, keyboard, touchscreen, or generally any suitable and desired machine-user interface.
The machine login system may comprise of:
   audio voice recognition
   audio phrase responses to questions,
   facial recognition, biometric or retina scan,
   RFID/Bluetooth or other near field technologies to log the user in based on pre authenticated devices such as a smart card, smart watch, smart finger ring or biometric implant
Generally, any suitable screen time constraint condition may be used as suitable and desired.

The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A screen time constraining device configured to monitor for satisfaction of a screen time constraint condition for a user, and when the screen time constraint condition is satisfied, prevent display of video information from a video information source selected by a user.

2. A device defined by claim 1 comprising a communications interface and a processor in communication with the communications interface, wherein the processor is configured to, when the screen time constraint condition is satisfied, send via the communications interface command information indicative of a command to switch the active source of video information from the user selected video information source to another source of video information.

3. A device defined by claim 2 wherein the other source of video information is the communications interface.

4. A device defined by claim 3 wherein the processor is configured to generate video information and send the generated video information to the communications interface.

5. A device defined by claim 4 wherein the generated video information is in a HDMI format.

6. A device defined by claim 2 wherein the communications interface comprises a High-Definition Multimedia Interface (HDMI).

7. A device defined by claim 2 including at least one of the command information and the command complies with the Consumer Electronics Control (CEC) protocol defined by a HDMI specification.

8. A device defined by claim 7 wherein the communications interface is in signal communication with an electronic display.

9. A device defined by claim 8 wherein the electronic display is the root device and has at least one of a physical address of 0 and a logical address of 0.

10. A device defined by claim 9 including a computer network interface for receiving, from a remote information store, accumulated screen time information indicative of the user's accumulated screen time on at least two electronic devices, and the screen constraint condition incorporates the accumulated screen time information, wherein one of the at least two electronic devices is in communication with the communications interface.

11. A device defined by claim 10 including a computer network interface for receiving, from an information store, accumulated screen time information indicative of the user's accumulated screen time on at least one electronic device, and the screen constraint condition incorporates the accumulated screen time information.

12. A device defined by claim 11 wherein the information store is a remote information store.

13. A device defined by claim 10 which the computer network interface comprises an IEEE 802.11 communications interface.

14. A device defined by claim 13 wherein the screen time display constraint condition defines a time the user is not permitted screen time.

15. A device defined by claim 14 wherein the screen time constraint condition defines a maximum quantity of screen time for the user.

16. A method for constraining screen time, the method including:
monitoring for satisfaction of a screen time constraint condition; and prevent display of video information from a video information source selected by a user.

17. Non-transitory processor readable tangible media including program instructions which when executed by a processor causes the processor to perform a method defined by claim 16.

18. A computer program for instructing a processor, which when executed by the processor causes the processor to perform a method defined by claim 17.

19. A device defined by claim 4 wherein the processor is configured to generate video information and send the generated video information to the communications interface. 20 (New) A device defined by claim 3 wherein the communications interface comprises a High-Definition Multimedia Interface (HDMI).
